(19) United States
(12) Patent Application Publication
(10) Pub. No.: US 2006/0144546 A1
(43) Pub. Date: Jul. 6, 2006

(54) Arrangement in an oscillator

(76) Inventor: Pentti Luoma, Jyska (FI)

Correspondence Address: STIENNON & STIENNON, 612 W. MAIN ST., SUITE 201, P.O. BOX 1667, MADISON, WI, 53701-1667, US

(21) Appl. No.: 11/313,399

(22) Filed: Dec. 21, 2005

(30) Foreign Application Priority Data
Dec. 22, 2004 (FI) 20045499

(51) Int. Cl. D21G 3/04; B31F 1/12; B31F 1/29

(52) U.S. Cl. 162/281

(57) ABSTRACT

An oscillator (17) is connected to a shaft (15), which is supported freely in the axial direction, by means of bearing support (16). The arrangement comprises elements (18) for both supporting the oscillator (17) to the bearing support (16) and for connecting it to the shaft (15). The elements (18) comprise an articulated structure (19) for providing a floating support for the oscillator (17) in relation to the bearing (16).

### CROSS REFERENCES TO RELATED APPLICATIONS

This application claims priority on Finnish App. No. 20045499, filed Dec. 22, 2004, the disclosure of which is incorporated by reference herein.

### BACKGROUND OF THE INVENTION

The present invention concerns an arrangement in an oscillator, where the oscillator is to be connected to a shaft, which is supported freely in the axial direction, by means of bearing support and where the arrangement contains elements for both supporting the oscillator to the bearing and for connecting it to the shaft.

For instance paper machines and other web-forming machines utilize several doctors which employ oscillators. An oscillator accomplishes a lateral oscillating movement on the beam, which improves the cleaning efficiency and reliability of the doctor blade. In prior art solutions, the shaft of the doctor is supported by a bearing to which the oscillator is fastened rigidly. The oscillator also contains a specific journal which is connected to the shaft with a connecting piece. The journal together with the connecting piece allows all degrees of freedom except a tractive and thrust motion.

The connecting piece is intentionally provided with clearances which are used for controlling the position deviations, inaccuracies and plays between the various parts. Clearances are required in particular in order to compensate the angle error, which is created when the doctor beam deflects, between the journal of the oscillator and its mounting surface. Because of the clearance, the movement of the doctor stops for a while when the oscillation direction changes. This stresses the mechanism and excites vibrations in the doctor. The oscillator also takes up much space, which is a significant problem for instance on the calender where another, yet more inferior type of structure which contains even larger clearances needs to be used.

### SUMMARY OF THE INVENTION

The objective of the present invention is to accomplish a new type of arrangement for an oscillator, requiring less space and having smaller clearances than before. By using the arrangement according to the invention, the oscillator can be accommodated in a smaller space than before, so that the use of more inferior structural solutions can be avoided for instance on calenders. This also prevents the generation of vibration excitation, which is typical of prior art connecting pieces, because the arrangement according to the invention is almost free of clearances.

In the following, the invention is described in more detail with reference to the accompanying drawings describing some applications of the invention.

### BRIEF DESCRIPTION OF THE DRAWINGS

FIG. 1 is a schematic view of a doctor in the machine direction, seen from the front.

FIG. 2 is an arrangement according to the invention in partial cross section.

FIG. 3 is an exploded view of some of the parts of the arrangement shown in FIG. 2.

### DESCRIPTION OF THE PREFERRED EMBODIMENTS

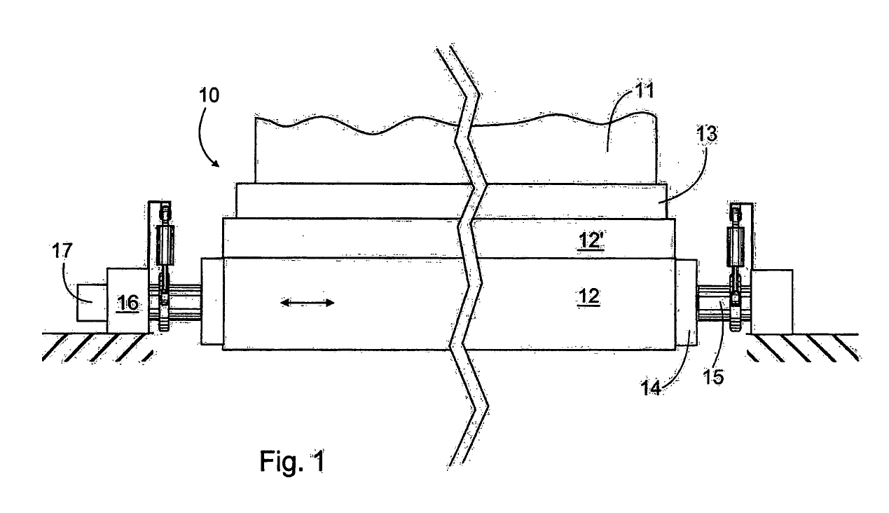

FIG. 1 shows a doctor 10 which works in conjunction with a roll 11. The surface of the roll 11 is doctored by a doctor blade 13 which is installed in the blade holder 12′ and which points diagonally up in the figure. The blade holder 12′ is fastened to the beam 12 of the doctor 10. The beam gives the doctor sufficient rigidity so that the doctor can be supported at its ends only. Alongside a beam, some other sufficiently rigid structure can be used. Shafts 15 are fastened to the ends of the beam 12 by means of flanges 14, and the shafts 15 are supported to the structure of the paper machine by means of bearings 16. These prior art bearings have a special design so that they allow both the turning of the beam in relation to the bearing and the movement of the beam in the axial direction. The bearing also allows angle errors in the shaft. In FIG. 1, the other end of the axial line also has an oscillator 17 which is of some prior art type. The oscillator 17 creates a reciprocating linear motion on the beam 12, with this motion being referred to with the two-headed arrow in FIG. 1. The length of stroke of the oscillator is typically 10-20 mm.

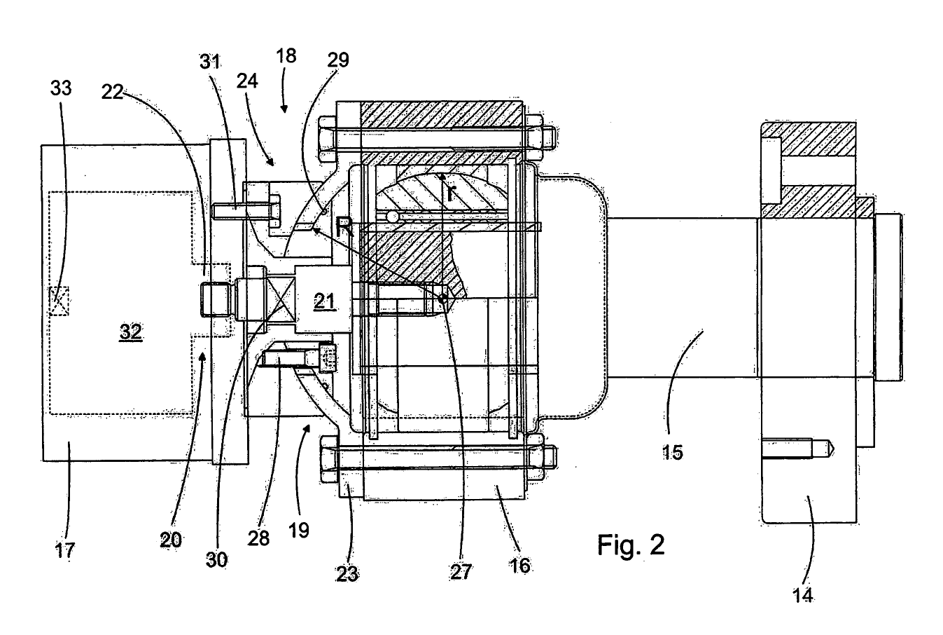

In other words, the oscillator 17 is intended to be connected to a shaft 15, which is supported freely in the axial direction, by means of bearing support 16. Moreover, as shown in FIG. 2, the arrangement comprises elements 18 for both supporting the oscillator 17 to the bearing 16 and for connecting it to the shaft 15. The arrangement is hence generally related to the fastening of the oscillator. FIG. 2 shows a package ready for installation, comprising a flange 14, shaft 15, bearing 16, and oscillator 17. The elements 18 according to the invention comprise an articulated structure 19 for providing a floating support for the oscillator 17 in relation to the bearing 16. Moreover, the articulated structure 19 is arranged so that the shaft 20 included in the oscillator 17 is always essentially parallel with the shaft 15 despite angular variations in the shaft 15 in relation to the bearing 16. In this case, it is possible to use an intermediate shaft 21 included in the elements 18, with the intermediate shaft 21 fastened rigidly both to the oscillator 17 and to the shaft 15. In other words, the piston rod 22 of the oscillator is rigidly fastened to the shaft 15 by means of the intermediate shaft 21.

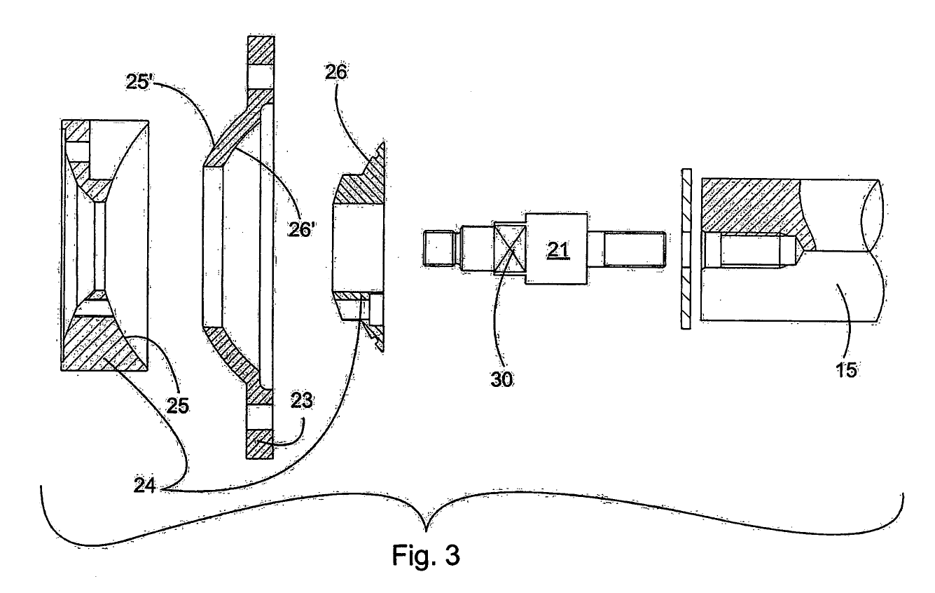

According to the invention, the articulated structure 19 comprises two pieces 23 and 24 which are arranged to move in relation to each other, with the pieces 23 and 24 having sliding surfaces 25, 25′ and 26, 26′, shown in FIG. 3, which correspond to each in order to achieve a floating support. The oscillator 17 can hence turn in accordance with the shaft 15 without damaging the oscillator. The angle error is normally approximately 1 degree. According to the invention, the sliding surfaces 25, 25′ and 26, 26′ are arranged as sectors of a spherical surface (FIG. 3). In the arrangement, the center of curvature of the spherical surface is essentially identical to the center of curvature 27 of the bearing 16. The floating spherical mounting face, however, transmits the tractive and thrust forces of the oscillator with small clearances.

The first piece 23 is fastened to the bearing 16 and the second piece 24 is fastened to the oscillator 17. Moreover, the second piece 24 has two parts, which facilitates the manufacture of the parts and the assembly of the arrangement. The parts of the piece 24 are also dimensioned so that the bolts 28 can be tightened easily. The second part also has a groove for a seal 29. The oscillator according to the invention can be removed without dismantling the articulated structure. For this purpose, the intermediate shaft 21 has a space 30 for a wrench. The piston 32 of the oscillator 17 also has a space 33 for a wrench. A gap large enough for a wrench can hence be created between the oscillator 17 and the articulated structure 19 by loosening the bolts 31. The joint between the intermediate shaft 21 and the piston rod 22 can be undone by holding the end of the piston 32 with another wrench. Mounting takes place in reverse order.

1. An oscillator arrangement for connection to a first shaft which is supported freely in an axial direction by a bearing support, the arrangement comprising:
an oscillator for connection to the first shaft; and
elements for both supporting the oscillator to the bearing support and for connecting the oscillator to the first shaft, the elements comprising an articulated structure which provides a floating support for the oscillator in relation to the bearing support, portions of the articulated structure being fixed to the oscillator, and portions of the articulated structure for attachment to the bearing support.

2. The oscillator arrangement of claim 1, wherein the oscillator has a second shaft, and wherein the articulated structure is arranged so that the oscillator second shaft is always essentially parallel with the first shaft despite angular variations in the first shaft in relation to the bearing support.

3. The oscillator arrangement of claim 1 wherein the elements comprise an intermediate shaft which is fastened rigidly both to the oscillator and to the first shaft.

4. The oscillator arrangement of claim 1 wherein the articulated structure comprises two pieces which are arranged to move in relation to each other, with the said pieces having sliding surfaces which correspond to each other in order to achieve the floating support.

5. The oscillator arrangement of claim 4 wherein the bearing support has a center of curvature, and wherein the sliding surfaces are arranged as sectors of a spherical surface, where the center of curvature of the spherical surface is essentially identical to the center of curvature of the bearing support.

6. An oscillator apparatus for mounting to a first shaft which is freely supported in an axial direction by a bearing support, the apparatus comprising:
an oscillator having a second shaft configured to be fixed to the first shaft; and
an articulated structure comprised of a first piece for being fixed to the bearing support, and a second piece which is fastened to the oscillator, the first piece being engaged within portions of the second piece to restrict axial movement while permitting turning to thereby define a floating support between the oscillator and the bearing support.

7. The oscillator apparatus of claim 6 wherein the first piece of the articulated structure engages with the second piece of the articulated structure so that the second shaft is always essentially parallel with the first shaft despite angular variations of the first shaft in relation to the bearing support.

8. The oscillator apparatus of claim 6 further comprising an intermediate shaft fixed to the oscillator second shaft and for fixed attachment to the first shaft.

9. The oscillator apparatus of claim 6 wherein the articulated structure first piece has sliding surfaces which correspond to sliding surfaces on the articulated structure second piece and, the sliding surfaces of the first piece and the second piece being arranged to move in relation to each other in order to achieve floating support.

10. The oscillator of claim 9 wherein the bearing support has a center of curvature, and wherein the sliding surfaces are sectors of a spherical surface having a center of curvature essentially identical to the center of curvature of the bearing support.

11. An oscillating apparatus comprising:
a bearing support;
a first shaft mounted to the bearing support and freely supported in an axial direction by the bearing support;
an oscillator having a second shaft which is fixed to the first shaft;
a first piece which is fixed to the bearing support;
a second piece which is fastened to the oscillator, the second piece being comprised of two parts, the second piece parts defining sliding surfaces which engage portions of the first piece therebetween to transmit tractive and thrust forces of the oscillator, the first piece and the second piece defining an articulated structure which provides a floating support between the oscillator and the bearing support.

12. The oscillating apparatus of claim 11 wherein the first piece of the articulated structure engages with the second piece of the articulated structure so that the second shaft is always essentially parallel with the first shaft despite angular variations of the first shaft in relation to the bearing support.

13. The oscillating apparatus of claim 11 further comprising an intermediate shaft fixed to the oscillator second shaft and to the first shaft.

14. The oscillating apparatus of claim 11 wherein the sliding surfaces define portions of a spherical surface.

15. The oscillating apparatus of claim 14 wherein the bearing support has a center of curvature, and wherein the sliding surfaces are sectors of a spherical surface having a center of curvature essentially identical to the center of curvature of the bearing support.
